(19) United States
(12) Patent Application Publication
(10) Pub. No.: US 2013/0124761 A1
(43) Pub. Date: May 16, 2013

(54) METHOD AND APPARATUS FOR MAINTAINING NETWORK COMMUNICATION DURING MAINTENANCE

(71) Applicants: David Elliott, Charlottesville, VA (US); Yu Zhang, Shanghai (CN); Darrell Halterman, Charlottesville, VA (US); Li Xu, Shanghai (CN); Weihua Shang, Shanghai (CN); Haifeng Wang, Shanghai (CN)

(72) Inventors: David Elliott, Charlottesville, VA (US); Yu Zhang, Shanghai (CN); Darrell Halterman, Charlottesville, VA (US); Li Xu, Shanghai (CN); Weihua Shang, Shanghai (CN); Haifeng Wang, Shanghai (CN)

(21) Appl. No.: 13/576,150

(22) PCT Filed: Feb. 8, 2010
(86) PCT No.: PCT/CN2010/000167

§ 371 Date: Jan. 4, 2013

(51) Int. Cl. G06F 13/12

(52) U.S. Cl. CPC G06F 13/122
USPC 710/32

(57) ABSTRACT

A communication method for use by an input/output (I/O) scanner coupled to a programmable logic controller (PLC) includes coupling at least one I/O module to a backplane, and coupling a maintenance module to the backplane. The communication method also includes selectively enabling and disabling communication between the backplane and the at least one I/O module by actuating a switch in the maintenance module such that network communication is maintained by a network interface regardless of whether communication between the backplane and the at least one I/O module is enabled.

### CROSS REFERENCE TO RELATED APPLICATIONS

This is a national stage application under 35 U.S.C. §371(c) of prior-filed, co-pending PCT patent application serial number PCT/CN10/000167, filed on Feb. 8, 2010 the entire contents of which are incorporated herein by reference.

### BACKGROUND OF THE INVENTION

The embodiments described herein relate generally to programmable logic controller (PLC) networks and. more particularly, to input/output (I/O) scanners for use with PLC networks.

At least some known I/O scanners include one or more I/O modules that are coupled to a backplane for transmitting and receiving data. Moreover, at least some known I/O scanners include a network interface that communicates with other network points, such as one or more PLCs. However, in order to service the I/O modules and/or the backplane of at least some known I/O scanners, a user must power down the I/O scanner, which results in a loss of network connectivity. If such an I/O scanner is part of a network that is a line topology or a ring topology, loss of network connectivity negatively impacts network performance across the entire network.

### BRIEF DESCRIPTION OF THE INVENTION

In one aspect, a communication method is provided for use by an input/output (I/O) scanner that is coupled to a programmable logic controller (PLC). The communication method includes coupling at least one I/O module to a backplane, and coupling maintenance module to the backplane. The communication method also includes selectively enabling and disabling communication between the back plane and the at least one I/O module by actuating a switch in the maintenance module such that network communication is maintained by a network interface regardless of whether communication between the backplane and the at least one I/O module is enabled.

In another aspect. an input/output (I/O) scanner is provided, including at least one I/O module, a backplane configured to couple to the at least one I/O module, and a maintenance module configured to selectively enable and disable communication between the backplane and the at least one I/O module.

In another aspect, an input/output (I/O) scanner is provided for use with a programmable logic controller (PLC) network. The I/O scanner includes a power supply. at least one I/O module, and a backplane configured to coupled to the at least one I/O module. The I/O scanner also includes a switch configured to selectively enable and disable communication between the backplane and the at least one I/O module, and at least one power circuit coupled to the power supply and the backplane, wherein the at least one power circuit is configured to control current flow between the power supply and the backplane based on whether communication between the backplane and the at least one I/O module is enabled or disabled.

### BRIEF DESCRIPTION OF THE DRAWINGS

The embodiments described herein may be better understood by referring to the following description in conjunction with the accompanying drawings.

FIG. 1 is a schematic block diagram of an exemplary programmable logic controller (PLC) network.

FIG. 2 is a schematic block diagram of an exemplary electrical architecture of an input/output (I/O) scanner that may be used with the PLC network shown in FIG. 1.

FIG. 3 is a schematic block diagram of an exemplary electrical architecture of a maintenance module that may be used with the I/O scanner shown in FIG. 2.

FIG. 4 is a flowchart that illustrates an exemplary communication method for use by the I/O scanner shown in FIG. 2.

### DETAILED DESCRIPTION OF THE INVENTION

Exemplary embodiments of methods and apparatus for use in maintaining network communications by an input/output (I/O) scanner while in a maintenance mode that enables service of a PLC backplane and/or one or more I/O modules coupled to the backplane are described hereinabove. The embodiments described herein facilitate maintaining a network topology, such as a line topology or ring topology, when one or more nodes or I/O scanners are in a maintenance mode.

Exemplary technical effects of the methods and apparatus described herein include at least one or (a) actuating a switch for a preselected time period: (b) in response to the actuation, selectively enabling and disabling communications between a backplane and one or more input/output (I/O) modules, and power supplied to the backplane by a power supply; and (c) maintaining communication ability with a network via a network interface regardless of whether communication between the backplane and I/O modules is enabled or disabled.

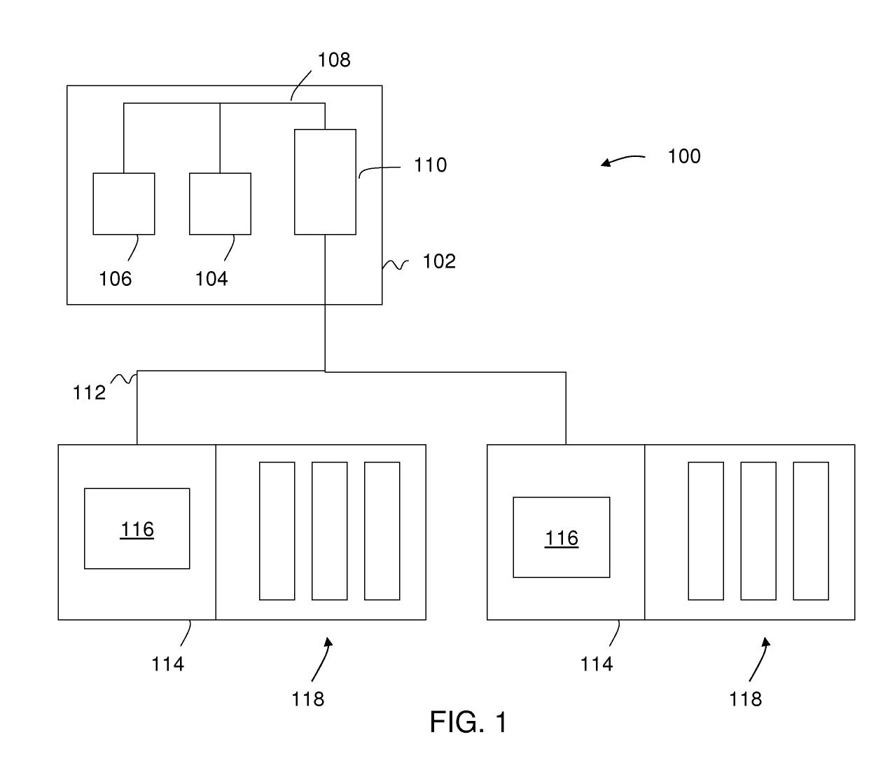

FIG. 1 is a schematic block diagram of an exemplary programmable logic controller (PLC) network 100 for use in, for example, an automation system. However, it should be understood that PLC network 100 may be used in any suitable system.

In the exemplary embodiment, PLC network 100 includes at least one PLC 102, which includes a processor 104 and a memory 106 coupled to processor 104 via a system bus 108. In alternative embodiments, PLC 102 may include multiple processors 104 and/or multiple memories 106. In the exemplary embodiment, PLC 102 also includes a network interface 110 that is coupled to system bus 108. Network interface 110 couples PLC 102 to a network 112, such as an automation network, to facilitate transmitting communication messages to other network nodes (not shown) Network 112 may be any suitable type of network including, but not limited to only including, an Ethernet network, an IEEE 802.11 wireless network, a reflective memory network, and a powerline network. Accordingly, network interface 110 may be any suitable type of network interface that facilitates transmitting communication messages via the selected network 112.

In the exemplary embodiment, PLC network 100 also includes one or more input/output (I/O) scanners 114. Each I/O scanner 114 includes a maintenance module 116 and one or more I/O modules 118 that receive data (input) from any suitable data source and transmit data (output) to any suitable data destination.

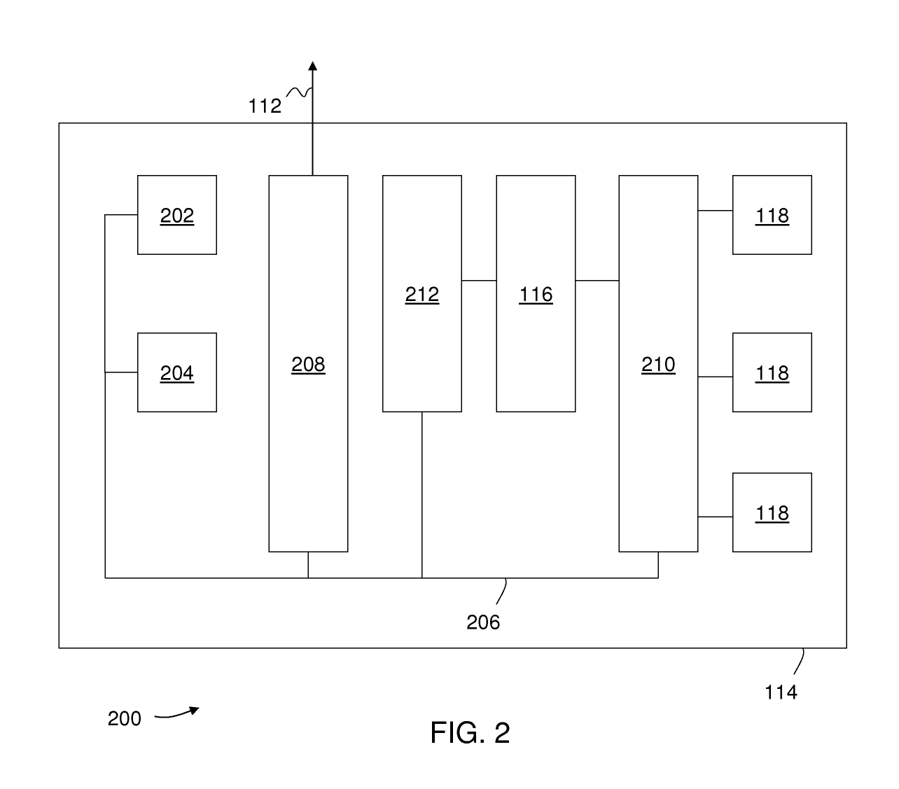

FIG. 2 is a schematic block diagram of an exemplary electrical architecture 200 of I/O scanner 114. In the exemplary embodiment, I/O scanner 114 includes a processor 202 and a memory 204 coupled to processor 202 via a system bus 206. In alternative embodiments, I/O scanner 114 may include multiple processors 202 and/or multiple memories 204. In the exemplary embodiment, I/O scanner 114 also includes a network interface 208 that is coupled to system bus 206. Network interface 208 couples I/O scanner 114 to network 112 to facilitate transmitting communication messages to, for example, PLC 102 (shown in FIG. 1). In an alternative embodiment, I/O scanner 114 includes multiple and/or redundant network interfaces 208.

Moreover, in the exemplary embodiment, each I/O module 118 is coupled to a backplane 210 that is also coupled to processor 202 and memory 204 via system bus 206. Backplane 210 transmits and receives data between processor 202 and I/O modules 118. Moreover, each I/O module 118 receives power from a power supply 212 via backplane 210. During operation, I/O scanner 114 scans, such as periodically scans, I/O modules 118 to transmit and/or receive data via backplane 210. In alternative embodiments, backplane 210 and/or I/O modules 118 are not components of I/O scanner 114. Rather, in such embodiments, backplane 210 and/or I/O modules 118 are externally coupled to I/O scanner 114.

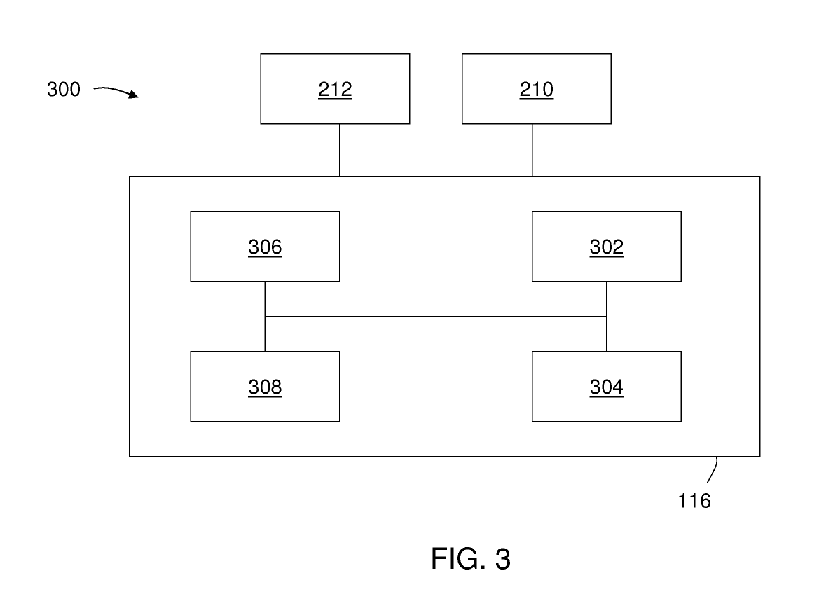

FIG. 3 is a schematic block diagram of an exemplary electrical architecture 300 of maintenance module 116. In the exemplary embodiment. maintenance module 116 selectively enables and disables communication and power to backplane 210 and/or I/O modules 118 (shown in FIGS. 1 and 2) to facilitate providing access to I/O modules 118 while I/O scanner 114 (shown in FIGS. 1 and 2) continues to receive and transmit network traffic via network interface 208 (shown in FIG. 2).

In the exemplary embodiment, maintenance module 116 includes a user-actuated switch 302 that selectively enables and disables communication and power to backplane 210 and I/O modules 118. In the exemplary embodiment, switch 302 is a pushbutton switch. However, switch 302 may be any suitable type of user-actuated device including, but not limited to only including, a toggle switch, a rotary switch, a rocker switch, and a touch sensitive switch. Switch 302 is used to transition I/O scanner 114 from an operating mode into a maintenance mode, thereby disabling communication and power to backplane 210 and I/O modules 118. Moreover, switch 302 is used to transition I/O scanner 114 from the maintenance mode into the operating mode, thereby enabling communication and power to backplane 210 and I/O modules 118. In the exemplary embodiment, switch 302 is positioned behind a door or cover (not shown) in a housing (not shown) of I/O scanner 114 to prevent accidental actuation. Moreover, in the exemplary embodiment, switch 302 is positioned within a recessed faceplate (not shown) that is located beneath the door or cover to prevent accidental operation.

Moreover, in the exemplary embodiment, maintenance module 116 includes a light device 304 that indicates a position of switch 302. More specifically, light device 304 indicates whether I/O scanner 114 is in the operating mode or the maintenance mode based on a position of switch 302. In the exemplary embodiment, light device 304 is a light emitting diode (LED). However, light device 304 may be any suitable type of device that emits one or more light colors or light intensities to indicate the position of switch 302. Maintenance module 116 also includes one or more power circuits 306 that are coupled to power supply 210 and to backplane 210. Power circuit 306 controls current flow between power supply 212 and backplane 210 when maintenance module 116 transitions between operating mode and maintenance mode to protect power supply 212 from the need to provide more power to backplane 210 than power supply 212 is capable of providing.

In the exemplary embodiment, maintenance module 116 also includes a microprocessor 308 that determines a time period that switch 302 is actuated. Microprocessor 308 compares, such as periodically compares, the time period to a preselected time period. If switch 302 has been actuated for a time period that is equal to or greater than the preselected time period, maintenance module 116 transitions operating state. For example, if maintenance module 116 begins in an operating mode and switch 302 is actuated for the preselected time period, such as three seconds, maintenance module 116 transitions to a maintenance mode. and disables communication and power to backplane 210 and I/O modules 118. Moreover, maintenance module 116 tri-states communications between I/O modules 118 and backplane 210. In an alternative embodiment, wherein switch 302 is, for example, a toggle switch or a sliding switch, maintenance module 116 transitions operating state based only on the position of switch 302. For example, if switch 302 is in a first position and is moved to a second position, maintenance module 116 transitions from operating mode to maintenance mode. Similarly, if switch 302 is moved from the second position to the first position, maintenance module 116 transitions from maintenance mode to operating mode.

Similarly, if maintenance module 116 begins in the maintenance mode and switch 302 is actuated for the preselected time period, such as three seconds, maintenance module 116 transitions to the operating mode, and enables communication and power to backplane 210 and I/O modules 118. Moreover, when switch 302 has been actuated for the preselected time period, microprocessor 308 transmits a signal to light device 304. In response to the signal, light device 304 indicates a change in operating status. For example, light device 304 does not emit light when maintenance module 116 is in the operating mode. In contrast, light device 304 emits a steady light when maintenance module 116 is in the maintenance mode. Alternatively, light device 304 may be periodically illuminated when maintenance module 116 is in the maintenance mode In some embodiments, maintenance module 116 will not change the operating state until a preselected amount of time, such as one half second, after switch 302 is released. Moreover, in some embodiments, a single actuation of switch 302 will not change the operating state more than once.

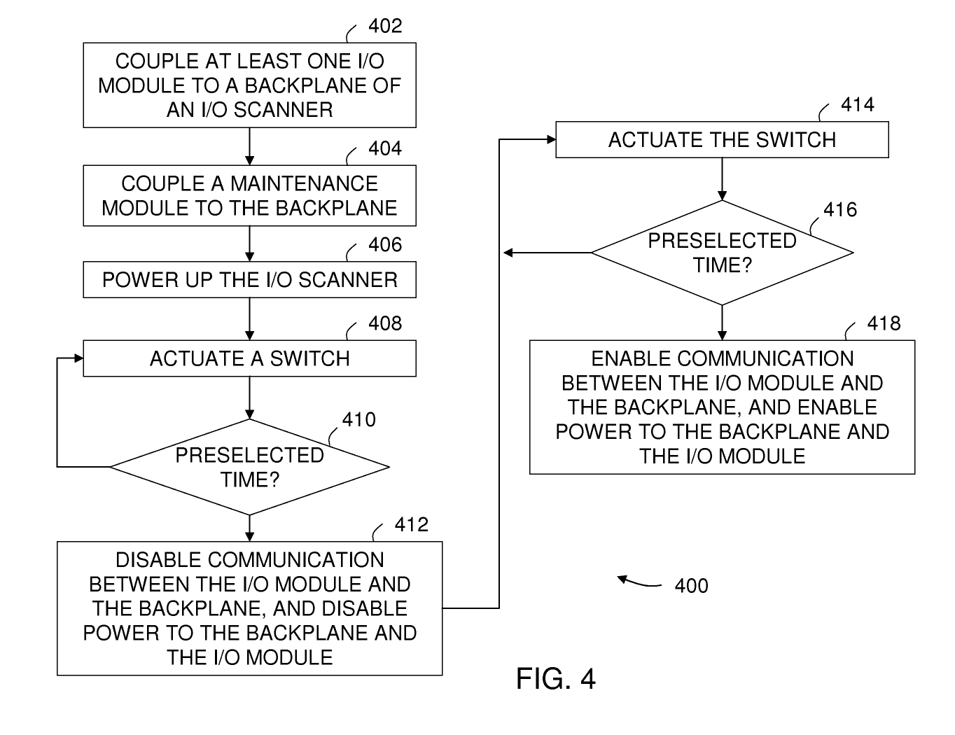

FIG. 4 is a flowchart 400 that illustrates an exemplary communication method for use by an I/O scanner, such as I/O scanner (shown in FIG, 2). In the exemplary embodiment, one or more I/O modules 118 are coupled 402 to backplane 210 (both shown in FIG. 2). In addition, maintenance module 116 (shown in FIG. 2) is coupled 404 to backplane 210 and to power supply 212 (shown in FIG. 2) More specifically, one or more power circuits 306 (shown in FIG. 3) are coupled to power supply 212 and backplane 210, and switch 302 (shown in FIG. 3) is coupled to back pl an e 210.

In the exemplary embodiment, and when received from the factory, I/O scanner 114 powers up 406 in an operating mode, wherein power supply 212 supplies power to backplane 212 to enable I/O scanner 114 to scan, such as periodically scan, for data from I/O modules 118. Moreover, when in the operating mode, light device 304 (shown in FIG. 3) is in a first state, such as an OFF state.

During operation, a user actuates switch 302 to selectively enable and disable communications between backplane 210 and I/O modules 118, and power supplied by power supply 212 to backplane 210 and I/O modules 118. Specifically, a user actuates 408 switch 302 for a preselected time period to transition maintenance module 116 (shown in FIG. 2) into a maintenance mode. Microprocessor 308 (shown in FIG. 3) determines a time period of actuation and compares 410 the time period to the preselected time period. When transitioning to the maintenance mode, maintenance modules 116 disables 412, or ceases, the power supplied to backplane 210 and I/O modules 118 by power supply 212. Moreover, maintenance module 116 disables 412 communication between backplane 210 and I/O modules 118. More specifically, maintenance module 116 tri-states communications between I/O modules 118 and backplane 114. Moreover light device 304 indicates that I/O scanner 114 is in maintenance mode via, for example, a steady-state light or a blinking light. When in maintenance mode, I/O modules 118 may be serviced and/or replaced and backplane 210 may be serviced. Moreover, when in maintenance mode, I/O scanner 114 maintains a connection to network 112 (shown in FIG. 1) via network interface 208 (shown in FIG. 2).

Upon completion of any service tasks, the user again actuates 414 switch 302 for the preselected time period to transition maintenance module 116 into the operating mode. Microprocessor 308 determines a time period of actuation and compares 416 the time period to the preselected time period. When transitioning to the operating mode, maintenance module 116 enables 418 communication between backplane 210 and I/O modules 118. Moreover, maintenance modules 116 enables 418 the power supplied to backplane 210 and I/O modules 118 by power supply 212. Moreover, light do ice 304 indicates that I/O scanner 114 is in the operating mode.

In the exemplary embodiment, when I/O scanner 114 is in the maintenance mode, PLC 102 (shown in FIG. 1) attempts, such as repeatedly or periodically attempts, to reconnect to any removed or powered-down I/O modules 118. When I/O scanner 114 transitions into the operating mode, PLC 102 is again successfully to connect to recently-serviced or new I/O modules 118, and will reconfigure such I/O modules 118. In an alternative embodiment, when maintenance module 116 transitions into the operating mode from the maintenance mode, any newly added I/O modules 118 will not be configured by I/O scanner 114 using a previously-used configuration file. Rather, I/O scanner 114 will establish a new application relationship with the newly added I/O modules 118, and will configure the newly added I/O modules 118 based on the new application relationship.

Moreover, in the exemplary embodiment, maintenance module 116 retains the current mode across power cycles. For example, if I/O scanner 114 loses power while maintenance module 116 is in maintenance mode, I/O scanner 114 will power up with maintenance module 116 in maintenance mode. Similarly, if I/O scanner 114 loses power while maintenance module 116 is in the operating mode. I/O scanner 114 will power up with maintenance module 116 in the operating mode.

Exemplary embodiments of methods and apparatus for use in maintaining network communications while in a maintenance mode are described above in detail. The methods and apparatus are not limited to the specific embodiments described herein but, rather, operations of the methods and/or components of the system and/or apparatus may be utilized independently and separately from other operations and/or components described herein. Further, the described operations and/or components may also be defined in, or used in combination with, other systems, methods, and/or apparatus, and are not limited to practice with only the systems, methods, and storage media as described herein.

A PLC or controller, such as those described herein, includes at least one processor or processing unit and a system memory. The PLC or controller typically has at least some form of computer readable media. By way of example and not limitation, computer readable media include computer storage media and communication media. Computer storage media include volatile and nonvolatile, removable and non-removable media implemented in any method or technology for storage of information such as computer readable instructions, data structures, program modules, or other data. Communication media typically embody computer readable instructions, data structures, program modules, or other data in a modulated data signal such as a carrier wave or other transport mechanism and include any information delivery media. Those skilled in the art are familiar with the modulated data signal, which has one or more of its characteristics set or changed in such a manner as to encode information in the signal. Combinations of any of the above are also included within the scope of computer readable media.

Although the present invention is described in connection with an exemplary automation system environment, embodiments of the invention are operational with numerous other general purpose or special purpose automation system environments or configurations. The automation system environment is not intended to suggest any limitation as to the scope of use or functionality of any aspect of the invention. Moreover the automation system environment should not be interpreted as having any dependency or requirement relating to any one or combination of components illustrated in the exemplary operating environment. Examples of well known automation systems, environments, and/or configurations that may be suitable for use with aspects of the invention include, but are not limited to, personal computers, server computers, hand-held or laptop devices, multiprocessor systems, microprocessor-based systems, set top boxes, programmable consumer electronics, mobile telephones, network PCs, minicomputers, mainframe computers, distributed computing environments that include any of the above systems or devices. and the like.

Embodiments of the invention may be described in the general context of computer-executable instructions, such as program components or modules, executed by one or more computers or other devices. Aspects of the invention may be implemented with any number and organization of components or modules. For example, aspects of the invention are not limited to the specific computer-executable instructions or the specific components or modules illustrated in the figures and described herein. Alternative embodiments of the invention may include different computer-executable instructions or components having more or less functionality than illustrated and described herein.

The order of execution or performance of the operations in the embodiments of the invention illustrated and described herein is not essential, unless otherwise specified. That is, the operations may be performed in any order, unless otherwise specified, and embodiments of the invention may include additional or fewer operations than those disclosed herein. For example, it is contemplated that executing or performing a particular operation before, contemporaneously with, or after another operation is within the scope of aspects of the invention.

In some embodiments, the term “processor” and/or the term “microprocessor” refers generally to any programmable system including systems and microcontrollers, reduced instruction set computers (RISC), application specific integrated circuits (ASIC), field-programmable gate arrays (FPGA), and any other circuit, processor, or controller capable of executing the functions described herein. The above examples are exemplary only, and thus are not intended to limit in any way the definition and/or meaning of the term “processor” and/or the term “microprocessor.”

In some embodiments, the term “memory” refers generally to any computer memory module including random access memory (RAM), read only memory (ROM), disc-based hard drives, solid state drives (SSD), removable memory cards, and any other device capable of storing the information described herein. The above examples are exemplary only, and thus are not intended to limit in an way the definition and/or meaning of the term “memory.”

When introducing elements of aspects of the invention or embodiments thereof, the articles “a,” “an”, “the,” and “said” are intended to mean that there are one or more of the elements. The terms “comprising,” including,” and “having” are intended to be inclusive and mean that there may be additional elements other than the listed elements.

This written description uses examples to disclose the invention, including the best mode, and also to enable any person skilled in the art to practice the invention, including making and using any devices or systems and performing an incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A communication method for use by an input/output (I/O) scanner coupled to at least one programmable logic controller (PLC), said communication method comprising:
coupling at least one I/O module to a backplane;
coupling a maintenance module to the backplane; and
selectively enabling and disabling communication between the backplane and the at least one I/O module by actuating a switch in the maintenance module such that network communication is maintained by a network interface regardless of whether communication between the backplane and the at least one I/O module is enabled.

2. A communication method in accordance with claim 1, wherein enabling communication between the backplane and the at least one I/O module comprises:
supplying power to the backplane, by the I/O scanner; and
scanning the at least one I/O module, by the I/O scanner.

3. A communication method in accordance with claim 1, wherein disabling communication between the backplane and the at least one I/O module comprises:
removing power from the backplane, by the I/O scanner; and
tri-stating communication signals between the I/O scanner and the backplane.

4. A communication method in accordance with claim 1, wherein the I/O scanner includes a light device, said communication method further comprising using the light device to indicate whether communication between the backplane and the at least one I/O module is enabled.

5. A communication method in accordance with claim 1, wherein the I/O scanner includes a switch and a microprocessor, said selectively enabling and disabling communication comprises using the microprocessor to determine a time period during which the switch is actuated into one of a first position associated with enabled communication and a second position associated with disabled communication.

6. A communication method in accordance with claim 1, wherein the I/O scanner includes a switch, said selectively enabling and disabling communication comprises:
enabling communication between the backplane and the at least one I/O module at a first position; and
disabling communication between the backplane and the at least one I/O module at a second position.

7. A communication method in accordance with claim 1, wherein the I/O scanner includes a power supply and at least one power circuit coupled to the power supply and the backplane, said communication method further comprising using the power circuit to control current flow between the power supply and the backplane when communication between the backplane and the at least one I/O module is enabled.

8. An input/output (I/O) scanner comprising:
at least one I/O module;
a backplane configured to couple to said at least one I/O module; and
a maintenance module configured to selectively enable and disable communication between said backplane and said at least one I/O module.

9. An input/output (I/O) scanner in accordance with claim 8, wherein when communication between said backplane and said at least one I/O module is enabled by said maintenance module, said I/O scanner is configured to supply power to said backplane and scan said at least one I/O module for I/O data, and wherein when communication between said backplane and said at least one I/O module is disabled by said maintenance module, said I/O scanner is configured to cease power supply to said backplane and tri-state communication signals betweens said at least one I/O module and said backplane.

10. An input/output (I/O) scanner in accordance with claim 8, further comprising a network interface configured to maintain communication with a network regardless of whether communication between said backplane and said at least one I/O module is enabled or disabled by said maintenance module.

11. An input/output (I/O) scanner in accordance with claim 8, wherein said maintenance module comprises a switch configured to:
enable communication between said backplane and said at least one I/O module at a first position; and
disable communication between said backplane and said at least one I/O module at a second position.

12. An input/output (I/O) scanner in accordance with claim 11, wherein said maintenance module further comprises a microprocessor coupled to said switch, said microprocessor configured to determine a time period during which said switch is actuated.

13. An input/output (I/O) scanner in accordance with claim 12, wherein said maintenance module is configured to:
disable communication between said backplane and said at least one I/O module in response to an actuation of said switch for a preselected period of time; and
enable communication between said backplane and said at least one I/O module in response to an actuation of said switch for a preselected period of time.

14. An input/output (I/O) scanner in accordance with claim 8, wherein said maintenance module comprises a light device configured to indicate whether communication between said backplane and said at least one I/O module is enabled or disabled.

15. An input/output (I/O) scanner in accordance with claim 8, further comprising a power supply, said maintenance module further comprising at least one power circuit coupled to said power supply and to said backplane, said at least one power circuit configured to control current flow between said power supply and said backplane when communication between said backplane and said at least one I/O module is enabled.

16. An input/output (I/O) scanner for use with a programmable logic controller (PLC) network, said I/O scanner comprising:
a power supply;
at least one I/O module;
a backplane configured to couple to said at least one I/O module;
a switch configured to selectively enable and disable communication between said backplane and said at least one I/O module; and
at least one power circuit coupled to said power supply and said backplane, said at least one power circuit configured to control current flow between said power supply and said backplane based on whether communication between said backplane and said at least one I/O module is enabled or disabled.

17. An I/O scanner in accordance with claim 16, wherein:
when communication between said backplane and said at least one I/O module is enabled, said I/O scanner is configured to supply power to said backplane from said power supply, and to scan said at least one I/O module for I/O data via said backplane; and
when communication between said backplane and said at least one I/O module is disabled, said I/O scanner is configured to cease power supply to said backplane, and tri-state communication signals between said at least one I/O module and said backplane.

18. An I/O scanner in accordance with claim 16, further comprising a light device configured to indicate whether communication between said backplane and said at least one I/O module is enabled or disabled.

19. An I/O scanner in accordance with claim 16, further comprising a microprocessor configured to determine a time period during which said switch is actuated, such that said I/O scanner is configured to selectively enable and disable communication between said backplane and said at least one I/O module in response to an actuation of said switch for a preselected period of time.

20. An I/O scanner in accordance with claim 16, further comprising a network interface configured to couple to the PLC network, said I/O scanner configured to maintain communication with the PLC network via said network interface regardless of whether communication between said backplane and said at least one I/O module is enabled or disabled.
